(19) United States
(12) Patent Application Publication
(10) Pub. No.: US 2026/0309284 A1
(43) Pub. Date: Oct. 8, 2026

(54) A HAZARDOUS FLUID ISOLATION SYSTEM

(71) Applicant: Fabrum IP Holdings Limited, Christchurch (NZ)

(72) Inventors: Jonas Matthias MEIER, Christchurch (NZ); Richard Hugh REYNOLDS, Christchurch (NZ)

(21) Appl. No.: 19/479,904

(22) PCT Filed: May 24, 2024
(86) PCT No.: PCT/IB2024/055052

§ 371 Date: Oct. 29, 2025

(30) Foreign Application Priority Data
May 23, 2023 (AU) 2023901636

(51) Int. Cl. F17D 1/08; F16L 23/18; F16L 39/00; F16L 59/075; F17D 5/04; F25J 1/00

(52) U.S. Cl. CPC F17D 1/08; F16L 23/18; F16L 39/00; F16L 59/075; F17D 5/04; F25J 1/001

(57) ABSTRACT

A hazardous fluid isolation system for processing a hazardous fluid having a barrier separating and defining a hazardous zone and a non-hazardous zone. The system has processing equipment for receiving and processing the hazardous fluid. The processing equipment is located in the non-hazardous zone and a pipe network fluidly connects the hazardous fluid source to the processing equipment. The pipe network comprising at least a first pipe extending partially in the non-hazardous zone and partially in the hazardous zone, the first pipe has a coupler for coupling a first section of the pipe extending from the hazardous zone to a second section of the pipe extending from the processing equipment. The first pipe comprises has an inner and an outer pipe surrounding the inner pipe to define a vacuum space and form a vacuum-insulated jacket encircling the inner pipe.

### FIELD OF THE INVENTION

The present invention relates to a hazardous fluid isolation system, and a method of isolating and processing hazardous fluid.

### BACKGROUND OF THE INVENTION

In some systems where hazardous fluids are involved, careful arrangement and selection of equipment and connections are required to keep the fluid safely contained. Often, such systems have a dedicated zone where the hazardous fluid remains in, and equipment operating in this zone may need to be specially designed to process the hazardous fluid safely.

An example of systems processing hazardous fluids are cryogenic systems which are used for producing, maintaining and storing cryogenic liquids or cryogens which are liquefied gases and other substances at very low temperatures. Cryogens are produced by liquefying gases by cooling them until they change state to liquid.

Cryogenic systems are now widely used in a number of different industries as they have proven to be useful in many different processes. However, these systems require careful management to ensure that dangerous events do not arise, such as due to leakages from pipes transporting the liquefied fluids.

The liquefied gases in pipelines may be generally at risk of causing damage if they expand rapidly in an uncontrolled environment such as during a leak, potentially causing an explosion. Robust systems are important, particularly such as when flammable gases are being liquefied, stored and transported, as escape of such material can react with the environment and cause extensive damage.

Cryogenic equipment located close and within the same area as the source material requiring processing and storing, especially where the source material is hazardous/ combustible, would cause damage if the source material escapes. To improve safety of these systems, the cryogenic equipment would need to be modified to reduce likelihood of leaks within the hazardous area which can be onerous and commercially unattractive. For example, where cryocoolers are located within the hazardous zone (same area as the hazardous source material), the systems can be difficult to construct, bulky, expensive and difficult to maintain.

Therefore, it could be desirable to provide a different hazardous fluid isolation system arrangement where the equipment does not require such extensive modification, while still enable the equipment to perform its intended function safely in a cryogenic system or other system processing hazardous fluids.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purpose of this specification, where method steps are described in sequence, the sequence does not necessarily mean that the steps are to be chronologically ordered in that sequence, unless there is no other logical manner of interpreting the sequence.

It is an object of the present invention to provide a hazardous fluid isolation system which overcomes or at least partially ameliorates some of the abovementioned disadvantages or which at least provides the public with a useful choice.

### BRIEF DESCRIPTION OF THE INVENTION

According to a first aspect the invention broadly comprises a hazardous fluid isolation system for processing a hazardous fluid comprising:
a barrier separating and defining a hazardous zone and a non-hazardous zone;
a processing equipment for receiving and processing the hazardous fluid, the processing equipment located in the non-hazardous zone;
a hazardous fluid source located in the hazardous zone for providing a hazardous fluid to be processed by the processing equipment; and
a pipe network configured to fluidly connect the hazardous fluid source to the processing equipment, the pipe network comprising at least a first pipe extending partially in the non-hazardous zone and partially in the hazardous zone;
the first pipe comprises a coupler for coupling a first section of the pipe extending from the hazardous zone to a second section of the pipe extending from the processing equipment; and
   the first pipe comprises:
      an inner pipe defining a passageway for fluid communication of the hazardous fluid between the processing equipment and the hazardous fluid source; and
      an outer pipe surrounding the inner pipe to define a vacuum space and form a vacuum-insulated jacket encircling the inner pipe.

According to another aspect the inner pipe and outer pipe comprises a concentric arrangement.

According to another aspect the inner pipe has a cross-sectional area of 75mm².

According to another aspect the outer pipe has a cross-sectional area of up to 4500 mm².

According to another aspect at least the first pipe comprises a coupler for coupling a first section of the pipe extending from the hazardous zone to a second section of the pipe extending from the processing equipment.

According to another aspect the coupler comprises a bayonet arrangement.

According to another aspect the bayonet arrangement comprises a male bayonet associated with the first or second section of the pipe and a female bayonet associated with the other of the first or second section of the pipe, and a connection surface where the male bayonet and the female bayonet abut.

According to another aspect the bayonet arrangement comprises a double O-ring arrangement.

According to another aspect a first O-ring is located at the connection surface, encircling the inner pipe.

According to another aspect a second O-ring is located at the connection surface, encircling the outer pipe.

According to another aspect the bayonet arrangement comprises a bleed hole configured to provide a path for leaked hazardous fluid from the inner pipe to the vacuum space between the inner pipe and outer pipe.

According to another aspect the bleed hole extends along a longitudinal direction of the pipe.

According to another aspect the bleed hole extends from the connection surface into the vacuum space of the second section of the pipe which is associated with the processing equipment.

According to another aspect the bleed hole extends from the connection surface into the vacuum space of both the first and second sections of the pipe which is associated with the hazardous fluid source and processing equipment respectively.

According to another aspect the bayonet arrangement comprises a first flange extending radially from the first pipe section, and a second flange extending radially from the second pipe section, and one or more fastening elements for holding the pipe sections together.

According to another aspect the bayonet arrangement comprises a bolted flange, wherein the one or more fastening elements is a plurality of bolts for securing the flanges together.

According to another aspect a permanent vacuum is provided in the vacuum space between the inner pipe and the outer pipe.

According to another aspect further comprising a vacuum pump to maintain the vacuum space between the inner pipe and the outer pipe.

According to another aspect further comprising a discharge point for venting and evacuation of potential hazardous fluid leak.

According to another aspect the pipe network comprises a supply line to the processing equipment, and an output line from the processing equipment.

According to another aspect the coupler is located at the non-hazardous zone.

According to another aspect the first section of the first pipe is located in both the hazardous zone and the non-hazardous zone.

According to another aspect the second section of the first pipe is located in the non-hazardous zone and not the hazardous zone.

According to another aspect further comprising a non-hazardous zone vacuum space enclosing equipment in the non-hazardous zone, the equipment at least including the processing equipment.

According to another aspect the non-hazardous zone vacuum space is open to the vacuum space associated with the second section of the first pipe.

According to another aspect the barrier is a non-permeable barrier.

According to another aspect the barrier is welded steel.

According to another aspect the hazardous fluid is a flammable fluid.

According to another aspect the hazardous fluid comprises hydrogen, methane, carbon monoxide, or combustible natural fluids.

According to another aspect the processing equipment is for heating or cooling the hazardous fluid.

According to another aspect the processing equipment comprises a heat exchanger.

According to another aspect the system is a cryogenic system for liquefying a hazardous gas and the processing equipment is a cryocooler assembly.

According to another aspect the cryocooler assembly comprises a heat exchanger for cooling the hazardous fluid to form liquid cryogen.

According to another aspect the cryocooler assembly comprises a storage vessel for containing liquid cryogen.

According to another aspect a vacuum pump for providing the non-hazardous zone vacuum space.

According to another aspect an exhaust pipe extending from the non-hazardous zone configured to expel gas from the non-hazardous zone.

According to another aspect one or more sensors for monitoring the system.

According to another aspect at least one of the one or more sensors is a gas sensor located at the exhaust pipe to monitor the expelled gas.

According to another aspect at least one of the one or more sensors is a vacuum sensor located in the non-hazardous vacuum space to measure pressure in the non-hazardous vacuum space.

According to another aspect the invention broadly comprises a method of isolating and processing hazardous fluid comprising:
providing a hazardous fluid isolation system as defined in any one of the previous clauses;
pumping hazardous fluid from the hazardous zone to the processing equipment located in the non-hazardous zone.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 shows a schematic drawing of the hazardous fluid isolation system.

FIG. 2 shows a cross-sectional side view of a bayonet coupling sections of a pipe in the hazardous fluid isolation system.

FIG. 3 shows a cross-sectional end view of the bayonet coupling in FIG. 2, along line B.

FIG. 4 shows a cross-sectional side view of another bayonet coupling sections of a pipe in the hazardous fluid isolation system.

FIG. 5 shows a cross-sectional end view of the bayonet coupling in FIG. 2, along line A.

FIG. 6 shows a 3D schematic of the hazardous fluid isolation system.

### DETAILED DESCRIPTION OF PREFERRED EMBODIMENTS

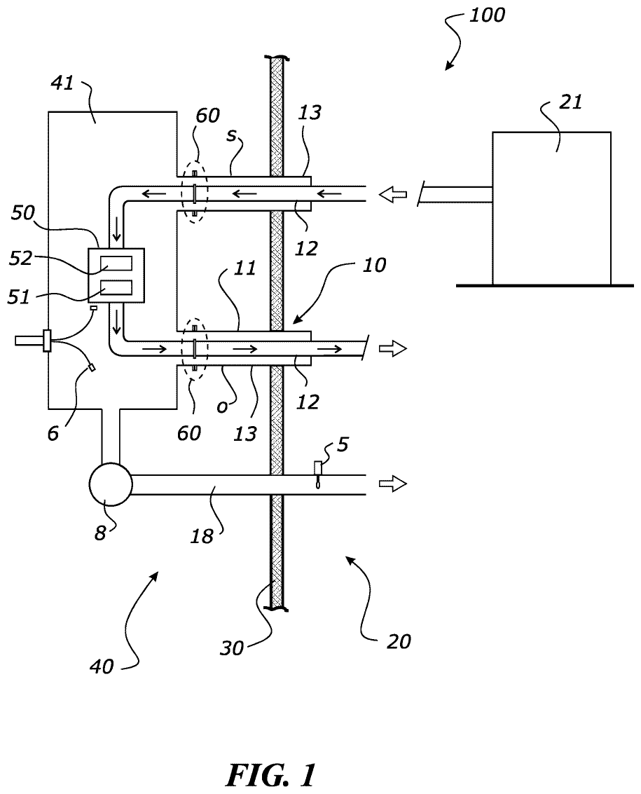

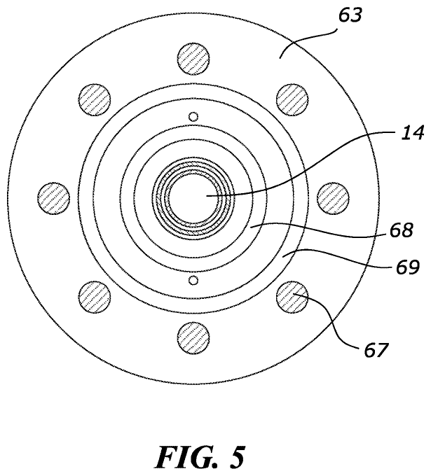

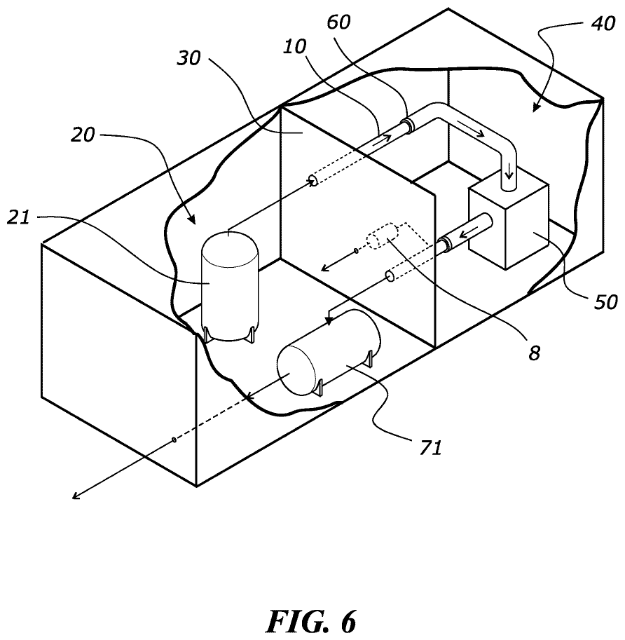

According to various aspects of the present invention as illustrated in FIGS. 1-6, there is provided a hazardous fluid isolation system 100 and a method of liquefying hazardous fluid which will now be described. It will be appreciated that these figures illustrate the general principles of the structure and construction, and that the invention is not limited to the precise configurations illustrated.

With reference to FIG. 1, the hazardous fluid isolation system 100 is generally indicated by the numeral 100.

The hazardous fluid isolation system 100 is configured to process a hazardous fluid. For example, the system may be a cryogenic system configured to produce cryogen by liquefying fluids. In the preferred configurations, the hazardous fluid isolation system 100 as herein described has been particularly designed to be suitable for processing hazardous fluids and providing a safe system and environment in doing so.

In the preferred configurations, a method of isolating and processing hazardous fluid comprises providing a hazardous fluid isolation system 100 as herein described and pumping hazardous fluid from the hazardous zone 20 to the processing equipment located in a non-hazardous zone 40.

In some configurations, the hazardous fluid being supplied and processed is a flammable fluid. For example, the hazardous fluid may be hydrogen, methane, carbon monoxide, or combustible natural gases. It is anticipated that other hazardous fluids such as toxic, corrosive, reactive or oxidizing, and the like may be present in the hazardous fluid isolation system 100.

It is also anticipated that a person skilled in the art may use this hazardous fluid isolation system 100 for processing other fluids, especially where additional safety arrangements are desired, such as to reduce the likelihood of leaked fluids entering unwanted spaces, or reducing cross-contamination of fluids etc.

As shown in FIG. 1, in the preferred configurations, the hazardous fluid isolation system 100 comprises a hazardous zone 20, and a non-hazardous zone 40. The hazardous zone 20 is to be understood to be where a hazardous fluid source 21 is located. The hazardous zone 20 may also be understood to be the zone in which the hazardous fluid is returned to. The intention is that the hazardous zone 20 contains appropriately rated equipment, venting, sensing etc. to manage any hazard presented by the type of fluid in that zone. In contrast, the non-hazardous zone 40 is intended to be able to have equipment which are not specifically rated to manage hazardous fluid as the hazardous fluid isolation system 100 is designed to separate and isolate the hazardous fluid from the atmosphere of the non-hazardous zone.

Preferably, the hazardous fluid isolation system 100 comprises a barrier 30 for separating and defining the hazardous zone 20 and non-hazardous zone 40, as best illustrated in FIG. 6.

Preferably, the barrier 30 is a non-permeable barrier. The term non-permeable barrier may be defined as being a barrier formed from a material where fluids (water and vapour/fluids) are unable to pass or at least has a very high threshold of not allowing fluids to pass.

In some configurations, the barrier 30 is welded steel. It should be appreciated, other material known to a person skilled in the art may be utilised to provide the non-permeable barrier such as another metal (e.g. aluminium), or plastic or a composite.

It should be understood that the hazardous and non-hazardous zones 20, 40 are separate and defined spaces. Preferably, the zones are not provided by a housing to form a space within the other space. In some configurations, the hazardous zone 20 and non-hazardous zone 40 are separate and adjacent rooms, as best shown in FIG. 6. In other configurations, the hazardous zone 20 and non-hazardous zone 40 are within the same room, however, are separated by the barrier 30. Preferably, the barrier 30 provides a wall to separate the zones.

Having separate hazardous and non-hazardous zones 20, 40 may provide advantages such as allowing for providing a safety barrier and separation where hazardous fluids are being transferred and processed. Further, it allows equipment to be separately located within the non-hazardous zone 40 which generally reduces conditions required of the equipment. Use of equipment in the hazardous zone 20 may have difficult safety conditions and regulations to adhere to, where designing for those hazardous fluid isolation systems 100 can be onerous and commercially unattractive. When operating with flammable and/or explosive environments, key equipment should either be isolated from the environment or approved to work within it. Approval or certification of such equipment to operate within a hazardous environment 20 may be difficult to construct, resulting in a bulky product, equipment difficult to maintain and/or expensive to manufacture.

In the preferred configurations, a processing equipment 50 is located in the non-hazardous zone 40. Preferably, the processing equipment 50 is not located in the hazardous zone 20. The processing equipment 50 is separate and isolated from hazardous zone 20.

Preferably, the processing equipment 50 is spaced from and separate from the hazardous zone 20 by the barrier 30. A processing equipment 50, being separately located from the hazardous zone can reduce the onerous and expensive regulations which would typically be required by equipment located in the hazardous zone.

In the preferred configurations the hazardous fluid isolation system 100 enables the use of processing equipment e.g. cryocoolers that are not rated for hazardous environments e.g. flammable gas environments to liquefy hydrogen. Having the flow space of hydrogen completely enclosed by a continuous vacuum space within the non-hazardous area enables that non-rated equipment to be safely used because there is certainty that the space will not have hydrogen in it.

In some preferred configurations, the processing equipment 50 is equipment for heating or cooling the hazardous fluid. In some configurations, the processing equipment 50 comprises a heat exchanger for transfer of heat to or from the hazardous fluid.

In some configurations, such where the system is a cryogenics system, the processing equipment 50 is a cryocooler assembly. The cryocooler in these configurations are to be located in the non-hazardous zone 40. As it is located separate from the hazardous zone 20 by the barrier 30, the cryocooler used in the system may be a more cost-efficient option as it does not need more onerous features to satisfy regulations associated with operating in a more hazardous area. The non-hazardous zone 40 may contain more than one cryocooler assembly 50. For example, in some configurations, depending on the application, several cryocoolers may be used.

Preferably, the cryocooler assembly 50 comprises a heat exchanger 51 for cooling the hazardous fluid to form liquid cryogen.

Preferably, the cryocooler assembly 50 comprises a storage vessel 52 for containing the liquid cryogen. Preferably, the storage vessel 52 is located in the non-hazardous zone 40.

Preferably, other equipment such as electrical control equipment is provided in the non-hazardous zone 40.

In summary, in the preferred configurations, some key equipment such as one or more cryocoolers (or other processing equipment) are located within the non-hazardous zone 40 to reduce regulatory burden, while the source hazardous fluid 21 can still be fed through to the cryocooler assembly 50 from the non-hazardous zone.

As shown in the hazardous fluid isolation system 100 layout of FIG. 1, the hazardous fluid source 21 is located in the hazardous zone 20. The hazardous fluid source 20 provides a hazardous fluid to be processed by the processing equipment 50. The hazardous fluid source may be supplied from a compressed fluid vessel or a fluid pipeline. In some configurations, the fluid may be manufactured or modified in the hazardous zone 20.

Preferably, the hazardous fluid source 21 is contained within the hazardous zone 20. The hazardous fluid source 21 is separate and isolated from the non-hazardous zone 40.

Typically, the hazardous zone 20 will have additional conditions and checks to maintain the safety of the zone and equipment within that zone. For example, the hazardous zone 20 may require ventilation and discharge of any vented fluids to a remote location at a prescribed distance from the hazardous zone to ensure the hazardous substances are diluted, rendered inert or discharged to a safe location.

In the preferred configurations, the hazardous fluid isolation system 100 comprises a pipe network 10. The pipe network 10 is configured to fluidly connect the hazardous fluid source 21 to the processing equipment 50.

Preferably, the pipe network 10 comprising at least a first pipe 11 extending partially in the non-hazardous zone 40 and partially in the hazardous zone 20. In these configurations, the pipe 11 connects equipment between the two zones 20, 40 (hazardous and non-hazardous zones.) In these preferred arrangements, the pipe 11 provides a passageway 14 to carry the hazardous fluid to or from the non-hazardous zone 40.

In some configurations, the fluid passing both to and from the hazardous gas zone 20 and the non-hazardous zone 40 via the pipe network 10 is hazardous fluid. In other configurations, the hazardous fluid flowing in the pipe network 10 may be only flowing either into or out of the non-hazardous zone 40, but not both (i.e. hazardous fluid may flow in one direction, while non-hazardous fluid may flow in another direction after being processed by equipment in the non-hazardous zone).

For example, in some configurations, fluid passing from the hazardous gas zone 20 to the non-hazardous zone 40 is hazardous fluid, and fluid passing back to the hazardous zone is non-hazardous fluid. In these configurations, the hazardous fluid may be rendered non-hazardous in the non-hazardous zone before exiting from the non-hazardous zone. For example, hazardous fluid, such as hydrogen gas may pass from the hazardous zone 20 to the non-hazardous zone 40, and within the non-hazardous zone a fuel cell may process the hazardous hydrogen gas and air into a non-hazardous output such as electricity and water. Any returning fluid to the hazardous zone 20 may therefore be non-hazardous.

In another configuration, fluid passing from the hazardous gas zone 20 to the non-hazardous zone 40 is non-hazardous fluid, and fluid passing to the hazardous zone is hazardous fluid. For example, an electrolyser may process (non-hazardous) water into (hazardous) hydrogen and oxygen within the non-hazardous zone 40. Therefore, the returning fluid to the hazardous zone 20 will be hazardous.

In some configurations, fluid in the non-hazardous zone 40 may enter or exit to another adjoining non-hazardous zone. The exiting fluid in these configurations do not return to the hazardous zone 20.

As shown in the figures, at least a first pipe 11 comprises an inner pipe 12 defining a passageway 14 for the hazardous fluid to travel. The inner pipe 12 allows fluid communication of the hazardous fluid between the processing equipment 50 and the hazardous fluid source 21.

Preferably, the pipe 11 also has an outer pipe 13 surrounding the inner pipe 12 to define a vacuum space 15. The vacuum space 15 forms a vacuum-insulated jacket encircling the inner pipe 12.

Firstly, the vacuum-insulated jacket 15 is designed to insulate the material travelling through the inner pipe 12 from the external environment, as temperature of such material should be carefully maintained. Within a hazardous fluid isolation system 100, unintended temperature changes may have damaging consequences. This may be particularly evident, if the pipe is transporting liquefied fluids (downstream from the cryocooler). Temperature insulation for non-cryogenic applications (for example in systems where the fluid is to be processed at low temperatures but not at cryogen levels, or at warm or hot temperatures), may also be important.

Secondly, the vacuum-insulated jacket 15 can provide a safety barrier against leaked hazardous fluid being transported via the inner pipe 12 from escaping into the surrounding environment. It should be appreciated the entire hazardous fluid flow path through the non-hazardous zone is isolated by the vacuum provided in the vacuum-insulated jacket such that the non-hazardous zone 40 is protected from any flow of hazardous fluid leaking from the inner pipe into the non-hazardous zone.

The vacuum arrangement and leak pathway will be discussed in more detail below.

Preferably, the inner pipe 12 and outer pipe 13 comprises a concentric arrangement.

Preferably, the vacuum space 15 provided between the inner pipe 12 and outer pipe 13 comprises a thickness of at least 20 mm Preferably, the inner pipe 12 has a cross-sectional area of 75 mm².

Preferably, the outer pipe 13 has a cross-sectional area of up to 4,500 mm².

Preferably, the first pipe 11 comprises a length of 1,000 mm to 100,000 mm.

It should be appreciated these dimensions are examples of ranges which may be suitable for some hazardous fluid isolation systems 100. Different dimensions may be suitable for some applications, while following the same or similar principles of the hazardous fluid isolation system 100 described herein.

It should be appreciated at least one of the pipes of the hazardous fluid isolation system 100 comprises the vacuum jacket pipe arrangement described above. However, it should be appreciated many of the key pipes within the hazardous fluid isolation system 100 may also have this arrangement.

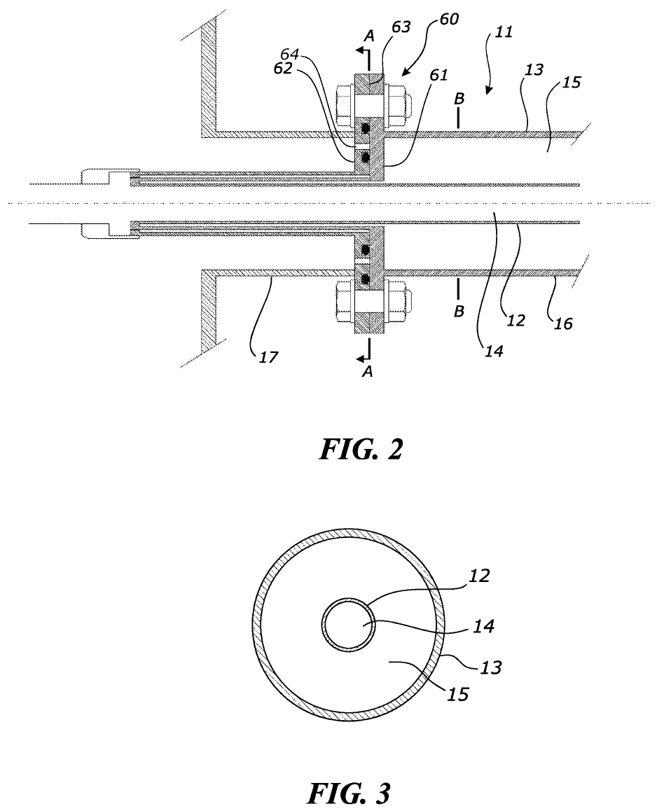

As referenced in FIG. 2, at least the first pipe 11 comprises two pipe sections coupled together. Preferably, the first pipe 11 comprises a corresponding coupler for coupling a first section 16 of the pipe extending from the hazardous zone 20 to a second section 17 of the pipe extending from the processing equipment 50.

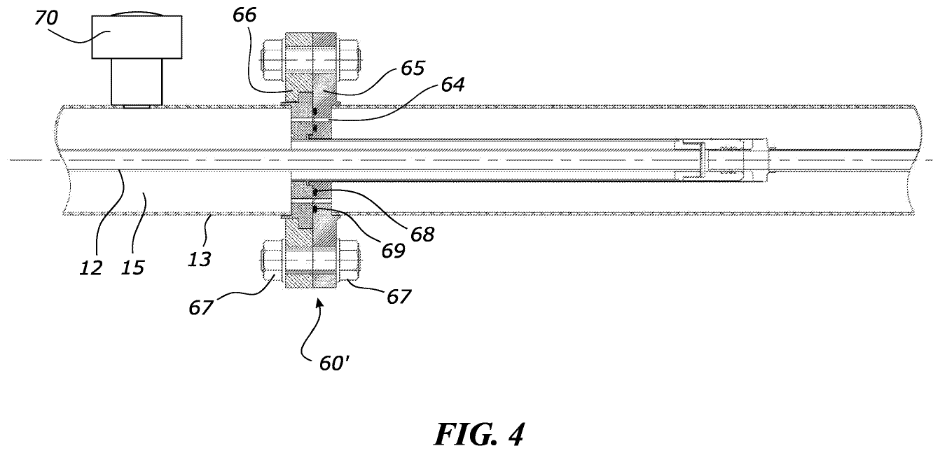

In some preferred configurations, the coupler comprises a bayonet arrangement 60, as best shown in FIGS. 2 and 4.

Preferably, the bayonet arrangement comprises a male bayonet 61 associated with the first or second section of the pipe 16, 17 and a female bayonet 62 associated with the other of the first or second section of the pipe. With reference to FIG. 2, in some configurations the male bayonet 61 is associated with the first section of the pipe 16 (extending from the hazardous zone) and the female bayonet is associated with the second section of the pipe 17 (extending from the cryocooler assembly).

The bayonet assembly comprises a connection surface 63 where the male bayonet 61 and the female bayonet 62 abut.

In some preferred configurations, the bayonet arrangement 60 comprises a double seal arrangement. In some bayonet arrangements, the double seal arrangement is a double O-ring arrangement 68, 69. The double O-ring arrangement is configured to seal and minimise leaks from pipe. O-rings are a convenient means of sealing. The O-rings supplement the bayonet and are intended to be suitable in temperatures for the specific use of the system (e.g. for cryogenic temperatures) as the seals are warm and therefore immune to freezing and shrinking. It should be appreciated other seals may be used such as gaskets or conformal metal seals or the like.

With reference to FIGS. 3 and 4, the bayonet arrangement 60 comprises a first O-ring 68 located at the connection surface 63 encircling the inner pipe 12. The first O-ring seals the contact surface 63 immediately surrounding the inner pipe 12, to reduce likelihood of leaking of the hazardous fluid from the inner pipe.

Preferably, the bayonet arrangement 60 comprises a second O-ring 69 located at the contact surface 63, encircling the outer pipe 11. The second O-ring seals the contact surface immediately surrounding the outer pipe 13, to reduce leak of fluid from the vacuum space 15 within the outer pipe 13.

In some preferred configurations, the bayonet arrangement 60 comprises a bleed hole 64, as shown in FIGS. 2 and 4, configured to provide a leak path for leaked hazardous fluid from the inner pipe 12 to the vacuum space 15 between the inner pipe and outer pipe 13. This leak path is intended to reduce the likelihood of hazardous fluids travelling directly from the inner pipe 12 out through towards the outer periphery of the outer pipe 13.

Preferably, the bleed hole 64 extends along a longitudinal direction of the pipe 11. As shown in FIGS. 2 and 4, the bleed hole 64 extends from the connection surface 63 and opens out into the vacuum space 15 between the inner and outer pipes 12, 13. Escaping fluid from the inner pipe 12 is configured to be directed into the vacuum space 15.

As referenced in FIGS. 3 and 4 the bayonet arrangement 60 has a first flange 65 extending radially from the first pipe section 16. The bayonet arrangement 60 also has a second flange 66 extending radially from the second pipe section 17. In these configurations, the first and second pipe sections each have a circular flange to provide at least part of the connection surface 63 where the first and second pipe sections 16, 17 abut.

The bayonet arrangement 60 has one or more fastening elements 67 for holding the pipe sections 16, 17 together.

In some configurations, the bayonet arrangement 60 comprises a bolted flange, wherein the one or more fastening elements is a plurality of bolts for securing the flanges together.

It is anticipated in other configurations, other fastening elements 67 known to a person skilled in the art may be used to secure the pipe sections together, for example a clamp.

In some configurations, as referenced in FIG. 2, a permanent vacuum is provided in the vacuum space 15 between the inner pipe 12 and the outer pipe 13. Having some permanent vacuum lines can offer advantages for reliability and commissioning. For example, a permanent vacuum jacket line can have the vacuum factory pumped and qualified separately from the rest of the system. These parts of the system can be used to isolate sections of the system e.g. separate from parts of the pumped vacuum system.

The vacuum may be established in the factory by applying vacuum using a specially designed pump-out port and pump-out port adapter at 70 as shown in FIG. 4. When the vacuum jacketed pipe has been suitably conditioned (by applying heat and vacuum over an extended period), the pump-out port adapter is used to apply an o-ring sealed plug to the port before removing the adapter. The vacuum jacketed pipe is designed to hold a vacuum permanently in this state without having to re-pump the vacuum space.

In other configurations, a pump remains connected to provide a pumped vacuum to the vacuum space 15 between the inner pipe 12 and the outer pipe 13. A vacuum pump (e.g. connected at port 70 as shown in FIG. 4) can maintain a continuous vacuum in the space 15 between the inner and outer pipe 13. By vacuum pumping one side of the bayonet, any leakage of hazardous fluid may be pumped away. Without providing a vacuum pump, a leakage of hazardous fluid could eventually eliminate the vacuum and degrade thermal insulation performance of the vacuum jacketed pipeline. Pumped vacuum has the advantage of being able to evacuate any hazardous fluid leak to a remote discharge point for detection and safe venting. Pumped vacuum also ensures the hazardous fluid cannot reach the non-hazardous zone 40.

In some configurations, as shown in FIG. 2, the bleed hole 64 extends from the connection surface 63 into the vacuum space 15 of the second section 17 of the pipe which is associated with the cryocooler assembly 50. In these configurations, the bleed hole 64 is intended to prevent hazardous fluid exiting the join to the non-hazardous zone 40.

In another configuration, as shown in FIG. 4, the bayonet arrangement 60′ has features which are the same or similar to the ones described above in and shown in FIG. 2. In this configuration, as illustrated in FIG. 4, a primary difference is that the bleed hole 64 extends from the connection surface 63 into the vacuum space 15 of both the first and second sections 16, 17 of the pipe which is associated with the hazardous fluid source 21 and processing equipment 50 respectively.

In some configurations, a pumped vacuum relies on the vacuum space being either continually or periodically pumped to keep the vacuum at a suitable level to provide the necessary insulation. In a pumped vacuum system, any hazardous fluid leakage will be pumped out of the vacuum space to where it can be detected at a remote exit point and safely discharged or treated to mitigate any hazard.

It should be appreciated that in the preferred configurations, the connection region between the first and second pipe sections 16, 17 has been carefully designed to provide a continuous flow path for materials travelling through the pipe. The connection region is a potential area for failure (typically more prone to fluid leaks than other regions of the system). Therefore, the features as described in this specification may help reduce the likelihood of leaks, or at least provide a leak pathway which reduces safety concerns.

In some configurations, as shown in FIG. 1, the pipe network 10 of the hazardous fluid isolation system 100 has a supply line (S) to the processing equipment 50, and an output line (O) from the processing equipment.

Preferably, the cryocooler assembly 50, pipe network 10, hazardous fluid source 21 forms a continuous connected system.

Preferably, the first section 16 of the first pipe is located in both the hazardous zone 20 and the non-hazardous zone 40 (e.g. this section of the pipe feeds the fluid from the hazardous fluid source 21/hazardous zone 20 into the non-hazardous zone 40 or returns fluid to the hazardous zone). While, preferably, the second section 17 of the first pipe is located in the non-hazardous zone 40 and not the hazardous zone 20 (e.g. this section of the pipe 17 extends from the processing equipment 50 to meet the first section 16 within the non-hazardous zone 40).

In some configurations, the hazardous fluid isolation system 100 has a non-hazardous zone vacuum space 41 enclosing equipment in the non-hazardous zone 40. Preferably, the equipment which is enclosed by the non-hazardous zone vacuum space 41 includes at least the processing equipment (e.g. the cryocooler assembly) 50. The vacuum space 41 is an environment provided (e.g. by a vacuum pump 8) to insulate and further protect equipment in the non-hazardous zone. It should be appreciated that the non-hazardous zone 40 is further protected and isolated from the hazardous zone 20 by the barrier 30 (described in more detail below).

Preferably, the hazardous fluid isolation system has a vacuum pump 8 for providing the non-hazardous zone vacuum space 41.

As shown in FIG. 1, in some configurations where there is the non-hazardous zone vacuum space 41, preferably it is open to the vacuum space 15 associated with the second section 17 of the first pipe. The non-hazardous zone vacuum space 41 and vacuum space 15 associated with the second section 17 of the first pipe is preferably continuous to form an integrated vacuum space.

The integrated vacuum spaces may be serviced together by a vacuum pump 8. Further, in some configurations, leaks can be detected by a sensor, e.g. a hydrogen sensor or other gas sensor 5 shown in FIG. 1 as the vacuum spaces (vacuum space surrounding the pipe and vacuum area surrounding the non-hazardous equipment) are interconnected. Other sensors may be used to detect leaks of the fluid being transported in the system.

In some configurations, the hazardous fluid isolation system 100 has an exhaust pipe 18 extending from the non-hazardous zone 40 configured to expel gas from the non-hazardous zone. The intention of the exhaust pipe 18 is to direct any hazardous fluid that may leak into the vacuum system out to the hazardous area (where equipment is suitably rated to match the hazard presented). For example, if the hazardous fluid is flammable, the hazardous area will have ATEX or similarly rated equipment so as not to provide ignition sources.

In the preferred configurations, the hazardous fluid isolation system 100 has one or more sensors for monitoring the system.

In some configurations, at least one of the one or more sensors is a hazardous fluid sensor 5 located at an exhaust pipe 18 to monitor expelled gas (from the vacuum space 41). The purpose of this sensor is to detect if there is a leak from the product line into the vacuum space. Another way to detect leakage into the vacuum space would be by monitoring the vacuum level for any degradation in the vacuum.

In some configurations, at least one of the one or more sensors is a vacuum sensor 6 located in the non-hazardous vacuum space 41 to measure pressure in the non-hazardous vacuum environment.

In summary, it should be appreciated, the hazardous fluid isolation system 100 which includes a barrier 30 to separate the hazardous and non-hazardous zones 20, 40, is an arrangement which can improve the safety of the system. Processing equipment 50 located in the non-hazardous zone will reduce the likelihood of safety concerns by separating and isolation of the equipment from the hazardous fluid source 21. This arrangement also provides a simpler, more robust and more commercially attractive option over systems where the equipment would be located within the hazardous zone 20. This is particularly advantageous where hazardous (e.g. flammable/combustible) fluids are being processed where typically high standards and regulations are involved.

In these configurations, the processing equipment 50 is located in the non-hazardous zone to provide a solution where the equipment does not require extensive modification (difficult to construct, bulky, expensive and difficult to maintain), while still enabling it to perform its intended function safely.

The arrangement of the zones and equipment works in synergy with the vacuum jacketed pipe(s) in the pipe network to provide a safe system.

Further advantages may be provided where the specific bayonet design as described is utilised. In some of these configurations, a double O-ring arrangement of the bayonet design may be used to seal the joining pipe sections, to minimise the risk of leaks, and to provide a specific leak pathway (i.e. encouraging leaked fluid to travel into the vacuum space, before exiting the pipe via the periphery of the joint.)

To those skilled in the art to which the invention relates, many changes in construction and widely differing embodiments and applications of the invention will suggest themselves without departing from the scope of the invention as defined in the appended claims.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

1. A hazardous fluid isolation system for processing a hazardous fluid comprising:
a barrier separating and defining a hazardous zone and a non-hazardous zone;
a processing equipment for receiving and processing the hazardous fluid, the processing equipment located in the non-hazardous zone;
a hazardous fluid source located in the hazardous zone for providing a hazardous fluid to be processed by the processing equipment; and
a pipe network configured to fluidly connect the hazardous fluid source to the processing equipment, the pipe network comprising at least a first pipe extending partially in the non-hazardous zone and partially in the hazardous zone;
wherein:
the first pipe comprises a coupler for coupling a first section of the pipe extending from the hazardous zone to a second section of the pipe extending from the processing equipment; and
the first pipe comprises:
an inner pipe defining a passageway for fluid communication of the hazardous fluid between the processing equipment and the hazardous fluid source; and
an outer pipe surrounding the inner pipe to define a vacuum space and form a vacuum-insulated jacket encircling the inner pipe.

2. The hazardous fluid isolation system of claim 1, wherein the inner pipe and outer pipe comprises a concentric arrangement.

3. The hazardous fluid isolation system of claim 1, wherein the coupler comprises a bayonet arrangement.

4. The hazardous fluid isolation system of claim 3, wherein the bayonet arrangement comprises a male bayonet associated with the first or second section of the pipe and a female bayonet associated with the other of the first or second section of the pipe, and a connection surface where the male bayonet and the female bayonet abut.

5. The hazardous fluid isolation system of claim 4, wherein the bayonet arrangement comprises a double O-ring arrangement.

6. The hazardous fluid isolation system of claim 5, wherein a first O-ring is located at the connection surface, encircling the inner pipe, and wherein a second O-ring is located at the connection surface, encircling the outer pipe.

7. (canceled)

8. The hazardous fluid isolation system of claim 4, wherein the bayonet arrangement comprises a bleed hole configured to provide a path for leaked hazardous fluid from the inner pipe to the vacuum space between the inner pipe and outer pipe, and wherein the bleed hole extends along a longitudinal direction of the pipe.

9. (canceled)

10. The hazardous fluid isolation system of claim 8, wherein the bleed hole extends from the connection surface into the vacuum space of the second section of the pipe which is associated with the processing equipment.

11. The hazardous fluid isolation system of claim 10, wherein the bleed hole extends from the connection surface into the vacuum space of both the first and second sections of the pipe which is associated with the hazardous fluid source and processing equipment respectively.

12. The hazardous fluid isolation system of claim 4, wherein the bayonet arrangement comprises a first flange extending radially from the first pipe section, and a second flange extending radially from the second pipe section, and one or more fastening elements for holding the pipe sections together.

13-17. (canceled)

18. The hazardous fluid isolation system of claim 1, wherein the coupler is located at the non-hazardous zone.

19. The hazardous fluid isolation system of claim 1, wherein the first section of the first pipe is located in both the hazardous zone and the non-hazardous zone, and wherein the second section of the first pipe is located in the non-hazardous zone and not the hazardous zone.

20. (canceled)

21. The hazardous fluid isolation system of claim 1, further comprising a non-hazardous zone vacuum space enclosing equipment in the non-hazardous zone, the equipment at least including the processing equipment.

22. The hazardous fluid isolation system of claim 21, wherein, the non-hazardous zone vacuum space is open to the vacuum space associated with the second section of the first pipe.

23-26. (canceled)

27. The hazardous fluid isolation system of claim 1, wherein the processing equipment is for heating or cooling the hazardous fluid, and wherein the processing equipment comprises a heat exchanger.

28. (canceled)

29. The hazardous fluid isolation system of claim 27, wherein the system is a cryogenic system for liquefying a hazardous gas and the processing equipment is a cryocooler assembly.

30-32. (canceled)

33. The hazardous fluid isolation system of claim 1, further comprising an exhaust pipe extending from the non-hazardous zone configured to expel gas from the non-hazardous zone.

34. The hazardous fluid isolation system of claim 1, further comprising one or more sensors for monitoring the system.

35. (canceled)

36. The hazardous fluid isolation system of claim 34, wherein at least one of the one or more sensors is a vacuum sensor located in the non-hazardous vacuum space to measure pressure in the non-hazardous vacuum space.

37. A method of isolating and processing hazardous fluid comprising:
providing the hazardous fluid isolation system of claim 1; and
pumping hazardous fluid from the hazardous zone to the processing equipment located in the non-hazardous zone.
